(19) United States
(12) Patent Application Publication
(10) Pub. No.: US 2008/0082346 A1
(43) Pub. Date: Apr. 3, 2008

(54) System and method for automated processing of returns

(76) Inventors: John M. Hoopes, Washington, IL (US); Pauline C. Agbodjan-Prince, Peoria, IL (US); Douglas C. Meyer, Morton, IL (US); Mary J. Swearingen, Bartonville, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/529,483

(22) Filed: Sep. 29, 2006

(51) Int. Cl. G06Q 10/00; G06Q 30/00

(52) U.S. Cl. 705/1

(57) ABSTRACT

A system and method are disclosed that provide for processing dealer returns. The system and method include receiving a list of parts from a dealer, wherein the list of parts includes at least one part the dealer seeks to return to a supplier of the part, and determining a return recommendation for each part included in the list of parts, wherein the return recommendation includes a suggested disposition for the part. The system and method further includes providing the return recommendation to the dealer and receiving a response to the return recommendation from the dealer. In addition, the system and method includes providing a return authorization to the dealer based on the return recommendation and the dealer response, wherein the return authorization includes an authorized disposition for each part on the list of parts.

### TECHNICAL FIELD

The present disclosure relates generally to a system and method for processing product returns, and more particularly, to a system and method for automated processing of dealer product returns.

### BACKGROUND

Parts distributors, including manufacturers and designers, often require processes to deal with returns from dealers who sell their parts. Parts returns from dealers generally fall into two broad categories, ad hoc returns and surplus dealer returns. Ad hoc returns are those items returned from a dealer on an ad hoc or unplanned basis. Ad hoc returns include items returned due to a change of mind, wrong or excess parts, damaged or defective part, and the like. Surplus dealer returns are excess inventory returns that a manufacturer authorizes for return on a scheduled basis. Surplus dealer returns are typically arranged by the parts distributor and occur on a periodic basis. While the parts distributor allows the dealer to submit a “wish list” of items they would like to return, it is not always to the benefit of the dealer to return the items on the list. Often a dealer will return items by means of the surplus dealer return program and then reorder the same part. This results in a greater cost to the dealer due to shipping and handling. It also reduces the probability that a dealer will have a part on hand when it is needed.

Systems and methods have been created to process surplus dealer inventory and dealer returns. One such example is U.S. Patent Publication Number 2002/0138373 (the '373 publication) to Reading et al., published on Sep. 26, 2002. The '373 publication discloses an inventory and parts management system and method. In the '373 publication, a web-based computer program qualifies and then queries dealers on a periodic basis to identify parts which the dealer wishes to return under one or more return policies. The web-based computer program identifies and matches dealers who wish to return parts with dealers who wish to buy those same parts.

Although the system and method of the '373 publication may be capable of identifying parts based on their profitability and movement and then assist dealers in offloading their less desirable parts, the system and method do not offer a way to assess a dealer's returns and provide feedback to the dealer. Thus, the system of the '373 publication does not offer a way to provide dealers with information regarding the financial benefit, or lack thereof, of offloading a part.

The disclosed system is directed to overcoming one or more of the problems set forth above.

### SUMMARY OF THE INVENTION

In one aspect, the present disclosure is directed to a system for processing dealer returns. The system includes a first computer system configured to generate and transmit a list of items for potential return, wherein the list of items includes at least one item. The system further includes a second computer system. The second computer system includes a memory including program code configured to process dealer returns and a processor configured to execute the program code. The second computer system is further configured to determine a return recommendation for each item included in the list of items received from the first computer system and determine a return recommendation for each item on the list of items, wherein the return recommendation includes a suggested disposition for the item. In addition, the second computer system is configured to provide a return authorization based on the return recommendation for any item identified for return by the first computer system.

In another aspect, the present disclosure is directed to a method for processing dealer returns. The method receives a list of parts from a dealer, wherein the list of parts includes at least one part the dealer seeks to return to a supplier of the part, and determines a return recommendation for each part included in the list of parts, wherein the return recommendation includes a suggested disposition for the part. The method further provides the return recommendation to the dealer and receives a response to the return recommendation from the dealer. In addition, the method provides a return authorization to the dealer based on the return recommendation and the dealer response, wherein the return authorization includes an authorized disposition for each part on the list of parts.

In another aspect, the present disclosure is directed to a computer-readable medium including instructions for performing a method, when executed by a processor, for processing dealer returns. The method receives a list of parts from a dealer, wherein the list of parts includes at least one part the dealer seeks to return to a supplier of the part, and determines a return recommendation for each part included in the list of parts, wherein the return recommendation includes a suggested disposition for the part. The method further provides the return recommendation to the dealer and receives a response to the return recommendation from the dealer. In addition, the method provides a return authorization to the dealer based on the return recommendation and the received response, wherein the return authorization includes an authorized disposition for each part on the list of parts.

### BRIEF DESCRIPTION OF THE DRAWINGS

FIG. 1 is a block diagram of an exemplary system architecture consistent with certain disclosed embodiments; and

FIG. 2 is a flow chart illustrating an exemplary process for securing a form consistent with certain disclosed embodiments.

### DETAILED DESCRIPTION

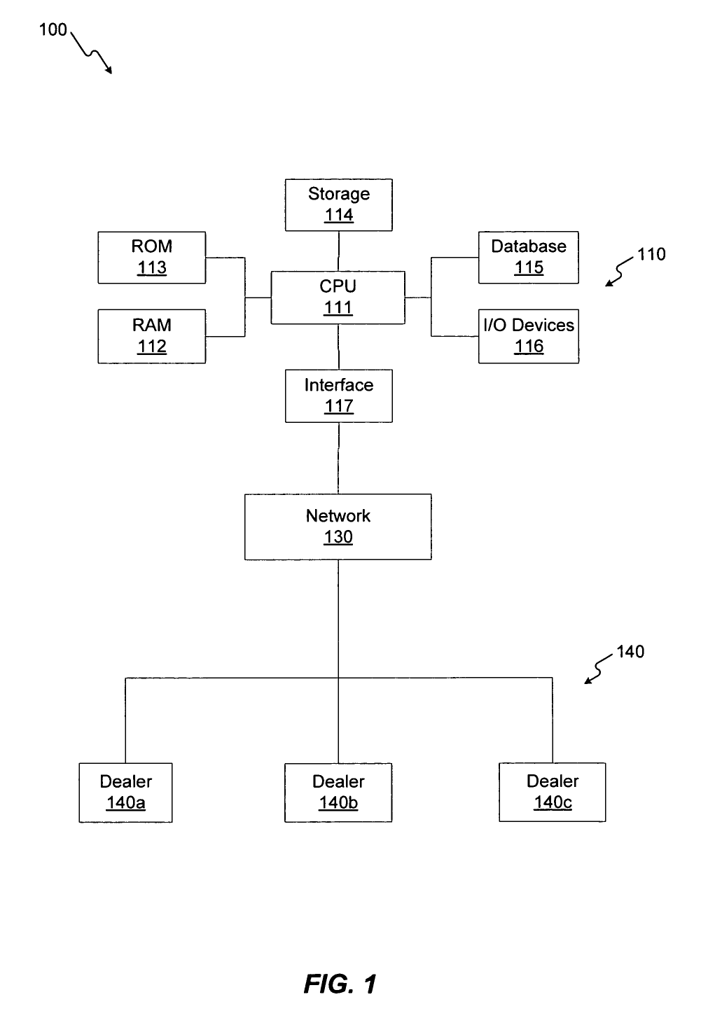

FIG. 1 illustrates an exemplary system architecture 100 in which principles and methods consistent with the disclosed embodiments may be implemented. As shown in FIG. 1, system architecture 100 may include one or more hardware and/or software components configured to collect, monitor, store, analyze, evaluate, distribute, report, process, record, and/or sort information associated with automated processing of dealer returns. For example, system architecture 100 may include return management computing system 110, network 130, and dealers 140.

Return management computing system 110 may include one or more hardware and/or software components such as, for example, a central processing unit (CPU) 111, a random access memory (RAM) module 112, a read-only memory (ROM) module 113, a storage 114, a database 115, one or more input/output (I/O) devices 116, and an interface 117. Return management computing system 110 may be configured to receive, collect, analyze, evaluate, report, display, and distribute data related to the automated processing of dealer returns and may use one or more software components or applications. For example, return management computing system 110 may be configured to manage, track, and forecast dealer and parts data and perform automated processing of dealer returns. Return management computing system 110 may be, for example, a mainframe, a desktop, a laptop, and the like.

CPU 111 may include one or more processors, each configured to execute instructions and process data to perform functions associated with return management computing system 110. As illustrated in FIG. 1, CPU 111 may be communicatively coupled to RAM 112, ROM 113, storage 114, database 115, I/O devices 116, and interface 117. CPU 111 may be configured to execute computer program instructions to perform various processes and methods consistent with certain disclosed embodiments. The computer program instructions may be loaded into RAM 112 for execution by CPU 111.

RAM 112 and ROM 113 may each include one or more devices for storing information associated with an operation of return management computing system 110 and/or CPU 111. For example, ROM 113 may include a memory device configured to access and store information associated with return management computing system 110, including information for identifying, initializing, and monitoring the operation of one or more components and subsystems of return management computing system 110. RAM 112 may include a memory device for storing data associated with one or more operations performed by CPU 111. For example, instructions from ROM 113 may be loaded into RAM 112 for execution by CPU 111.

Storage 114 may include any type of storage device configured to store any type of information used by CPU 111 to perform one or more processes consistent with the disclosed embodiments. For example, storage 114 may include one or more magnetic and/or optical disk devices, such as hard drives, CD-ROMs, DVD-ROMs, or any other type of media storage device.

Database 115 may include one or more software and/or hardware components that store, organize, sort, filter, and/or arrange data used by return management computing system 110 and/or CPU 111. Database 115 may include a relational, distributed, or any other suitable database format. A relational database may be in tabular form where data may be organized and accessed in various ways. A distributed database may be dispersed or replicated among different locations within a network. For example, database 115 may store historical information such as dealer purchasing and return history, parts data, parts sales data, and the like, associated with the management, tracking, and forecasting of parts sales and return data, or any other information that may be used by CPU 111 to perform automated processing of dealer returns. Database 115 may include analysis tools for analyzing information within the database. It is contemplated that database 115 may store additional and/or different information than that listed above.

I/O devices 116 may include one or more components configured to communicate information with a user associated with return management computing system 110. For example, I/O devices 116 may include a console with an integrated keyboard and mouse to allow a user to input parameters associated with return management computing system 110 and/or data associated with automated processing of dealer returns. I/O devices 116 may also include a user-accessible disk drive (e.g., a USB port, a floppy, CD-ROM, or DVD-ROM drive, etc.) to allow a user to input data stored on a portable media device. Additionally, I/O devices 116 may include one or more displays or other peripheral devices, such as, for example, a printer, a camera, a microphone, a speaker system, an electronic tablet, or any other suitable type of input/output device.

Interface 117 may include one or more components configured to transmit and receive data via network 130. In addition, interface 117 may include one or more modulators, demodulators, multiplexers, de-multiplexers, network communication devices, wireless devices, antennas, modems, and any other type of device configured to enable data communication via any suitable communication network. It is further anticipated that interface 117 may be configured to allow CPU 111, RAM 112, ROM 113, storage 114, database 115, and one or more input/output (I/O) devices 116 to be located remotely from one another and perform the method of collection, analysis, and distribution of data or other information.

Return management computing system 110 may include additional, fewer, and/or different components than those listed above and it is understood that the listed components are exemplary only and not intended to be limiting. For example, one or more of the hardware components listed above may be implemented using software. For example, storage 114 may include a software partition associated with one or more other hardware components of return management computing system 110. Additional hardware or software may also be required to operate return management computing system 110, such as, for example, security applications, authentication systems, dedicated communication system, etc. The hardware and/or software may be interconnected and accessed as required by authorized users. In addition, a portion, or all of, return management computing system 110 may be hosted and/or operated by a third party.

As discussed above, computer system may be in communication with network 130 by means of interface 117. Network 130 may be any appropriate communication network allowing communication between or among one or more entities. Network 130 may include, for example, the Internet, a local area network, a workstation peer-to-peer network, a direct link network, a wireless network, or any other suitable communication platform. Connection with network 130 may be wired, wireless, or any combination thereof.

Dealers 140a, 140b, and 140c may each represent a merchant, retailer, vendor, reseller, or other type of entity authorized to buy and/or return parts to a parts distributor. Dealers 140 may include primary dealers (i.e., parent dealers), secondary dealers (i.e., child dealers), and the like. Dealers 140 may connect to network 130 using any suitable computing device, such as, for example a desktop computer, a laptop computer, a mainframe computer, handheld computing device, a telephone, etc. The connection between dealers 140 and network 130 may be through any wired or wireless means.

### INDUSTRIAL APPLICABILITY

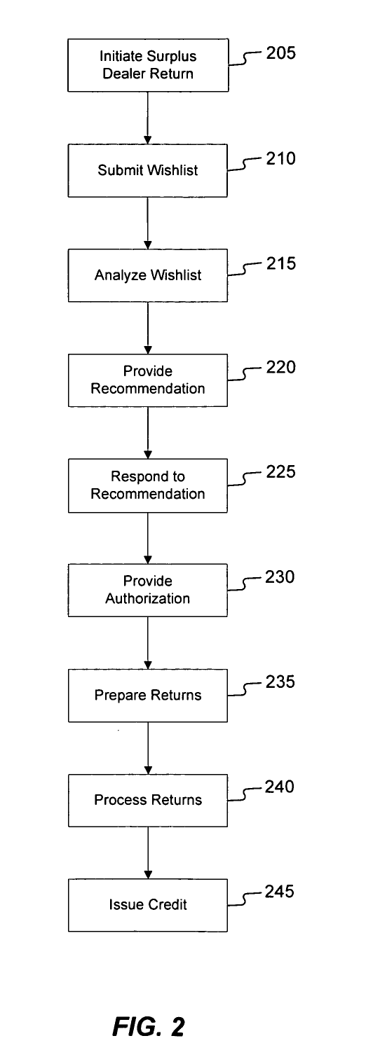

FIG. 2 illustrates a flowchart of an exemplary process for automated processing of surplus dealer returns consistent with certain disclosed embodiments. The process of FIG. 2 may be performed by return management computing system 110. For example, return management computing system 110 may execute one or more software programs that perform one or more of the process steps shown in FIG. 2. In one embodiment, a parts distributor may utilize return management computing system 110 to perform the method of the disclosed embodiment. Return management computing system 110 may be owned, operated, and/or supported, either in whole or in part, by a parts distributor. Furthermore, return management computing system 110 may be located in a facility or property owned, operated, and/or supported, either in whole or in part, by a parts distributor. Alternatively and/or additionally, return management computing system 110 may be owned, operated, and/or supported, either in whole or in part, by an return management computing entity, and returns management computer system 110 may receive, collect, store, analyze, evaluate, report, display and distribute data consistent with the certain disclosed embodiments. The return management computing entity may be, for example, a business or other organization configured to perform automated processing of returns on behalf of a parts distributor consistent with certain disclosed embodiments. A parts distributor may be any entity performing the task of distributing parts to one or more dealers and/or authorized resellers. The parts distributor may include, for example, a parts designer, a parts manufacturer, a parts warehouse, a parts supplier, etc. In addition, the parts may be utilized in a product and the parts distributor may be a product designer, a product manufacturer, a product warehouse, a product supplier, etc.

As mentioned above, dealer returns may be, for example, ad hoc returns or dealer surplus returns. In one exemplary embodiment, dealer returns may be dealer surplus returns and may occur on a regularly scheduled basis, e.g., biennially, annually, semiannually, quarterly, and the like. In addition, a predetermined return cycle period (e.g., a first, second, third, or fourth cycle period) may be targeted for a specific type of part, e.g., low dollar returns, high dollar returns, specific parts type returns, and the like. For example, dealer surplus returns may be scheduled by a parts distributor on a semi-annual basis using return management computing system 110, and every fourth return cycle may be targeted for low dollar returns, i.e., returns below a specified dollar amount.

As shown in step 205, return management computing system 110 may initiate a surplus dealer return for one or more dealers 140. The initiation of dealer surplus returns may be in the form of an invitation, or participation request, from the part distributor to one or more dealers 140. The invitation may be either paper-based or electronic, and may be provided in any form of media, including, for example, the Internet, Website posting, letter, e-mail, text message, instant message, newsletter, trade publication, and the like. The invitation may include data from database 115 and/or may request data from dealer 140. For example, the invitation may include parameters, such as, dealer name, dealer contact information, one or more part numbers and/or quantities, a response date, an issuing date (i.e., invitation date), future response and issuing dates, current and future return dates, invitation cycle information (e.g., first, second, third, fourth, etc.), related dealer information (e.g., child dealer, dealer group, etc.), dealer type, options for scraps and returns, a parts return authorization (PRA) number, country of origin information, and the like. The invitation may additionally request information from dealer 140, such as, for example, updated contact information, participation interest, and the like. The initiation of dealer surplus returns may be fully automated by return management computing system 110 using data found in database 115.

Once dealer 140 receives the invitation, dealer 140 may determine and submit a wishlist (step 210). The wishlist may be a list of parts or items the dealer 140 would like to return to the parts distributor. Dealer 140 may include in the wishlist part details, such as, for example, a part number, a part code, part type, part quantity, and country of origin. In addition, dealer 140 may include reasons for return, credit information, reply date, and the like. The wishlist may be submitted to return management computing system 110 for processing by any means of transferring information including, but not limited to, mail, courier, hand-delivery, and/or electronically. In one exemplary embodiment, the wishlist may be submitted electronically, i.e., email, Website, etc. In addition, an invitation may be received by dealer 140 once it is posted on a dealer-specific Website and submitted when the dealer 140 acknowledges receipt of the invitation on the dealer-specific Website.

Upon receipt of the completed wishlist, the return management computing system 110 may analyze each item on the wishlist (step 215). In one exemplary embodiment, return management computing system 110 may analyze the wishlist based on a predetermined set of criteria. For example, return management computing system 110 may automatically access database 115 to evaluate data, such as, for example, dealer purchasing and return history, part data, part sales data, and the like. Further, return management computing system 110 may categorize the parts on the wishlist according to one or more categories based on certain data, such as, sales movement, country of origin, type, and/or value of the part.

In one exemplary embodiment, return management computing system 110 may access database 115 and may use data found in database 115 to analyze each part based on sales movement. Sales movement may include a sale volume and sales velocity. Sales volume may be the total number of parts sold. Sales velocity may be the rate at which the dealer moves a part, that is, how fast it is sold after it is received. For example, parts that have high sales volume and high sales velocity may be placed in a first category, i.e., category “A.” Parts having a lower sales volume and lower sales velocity may be placed in a second category, i.e., category “B.” Parts that have the least sales volume and the lowest sales velocity may be placed in a third category, i.e., category “C.” Furthermore, return management computing system 110 may prioritize parts based on this information.

Each of the parts may be further analyzed to determine country of origin. Return management computing system 110 may use database 115 to evaluate a part according to a likelihood of the country of origin and the part may be categorized accordingly. For example, each part may be assigned a preferred country of origin based on a statistical probability that the part originated from that country. For instance, if the probability that a part originated in a first country is greater than the probability it originated from any other individual country, then return management computing system 110 may associate the preferred country of origin with the first country.

In addition, return management computing system 110 may analyze the wishlist to categorize each part according to one or more type category. Exemplary type categories include Excess Inventory Program (EIP) parts, replaced and discontinued parts, and specialized dealer returns (e.g., truck engine parts and the like). EIP parts may consist of one or more parts that have been identified as currently excessive to the supply chain. A part that has been categorized as EIP may be authorized for scrap instead of return, and dealer 140 may receive a credit for the part. The credit may be, for example, 100%, 90%, etc. of a dealer net price. In addition, parts that have been authorized for scrap but are returned by dealer 140 may be rejected by the parts distributor and may be returned to the sending dealer 140. In such a situation, the dealer 140 may be responsible for any and/or all costs associated with shipping, freight, and/or handling.

The replaced and discontinued parts category may include any part that is no longer sold, no longer manufactured, no longer supported by the manufacturer, and the like. Replaced and discontinued parts may be further analyzed to determine the time period relative to the replacement part release date. Based on the time period, the dealer 140 may be issued a credit. For example, a replaced part may be considered for return and credited at 100% of a dealer net price if returned within a first time period, e.g., within 36 months of release. However, that same part may be credited at 50% of dealer net price if returned within a second time period, e.g., after 36 months.

Parts that are categorized as a specialized return may be required to meet all of the following criteria: (a) replaced and discontinued parts, (b) surplus non-returnable parts with an extended dealer net value of a specified dollar amount, and (c) that have been sold to and returned by a specialized dealer. Items in this category which otherwise qualify for return authorization, may be credited at 100% of a dealer net price. In addition, parts returned in this category may require a specialized PRA number and may require one or more other conditions be met, e.g., specified return dollar amount, altered return schedule, etc.

Based on the analysis, return management computing system 110 may provide one or more return recommendations to dealer 140 for each item on the wishlist (step 220). The return recommendations may be a suggested disposition for each of the parts by the parts distributor based on the data returned by database 115. The suggested disposition may be the transfer of one or more parts to the ownership, possession, and/or title of another person, entity, organization, dealer, customer, and the like. In one exemplary embodiment, the return recommendation may be selected from a list of recommendations The return recommendations and/or list of recommendations may include, for example, recommendations to return one or more items to the parts distributor or other authorized receiving agent (e.g., warehouse, processing facility or agency, etc.), to maintain one or more items in the dealer's stock, to transfer one or more items to or from another dealer, to reorder one or more items from the parts distributor or authorized sales agent, to scrap one or more items, and the like. In one embodiment, the return recommendation may be provided in an electronic format, e.g., e-mail, Website, pager, and the like. In addition, the analysis and return recommendation may be fully automated by return management computing system 110 and may require no user interaction. For example, software processes may determine the return recommendation and generate a report according to a dealer profile. The report may be automatically provided to dealer 140 based on the profile and other predetermined reporting parameters.

When dealer 140 receives the one or more return recommendations, dealer 140 may provide a response (step 225). The response may be an acceptance or rejection of each of the recommendations. Additionally and/or optionally, dealer 140 may accept or reject the return recommendations either individually or as a group. The response may be in any form, such as, for example, electronic, paper-based, verbal, visual, audiovisual, or the like. In one exemplary embodiment, the acceptance or rejection may be made electronically using a computing device, such as, for example, a mainframe computer, a desktop, a laptop, a personal digital assistant, a telephone, and the like.

Once dealer 140 has responded to the return recommendation, the return management computing system 110 may provide one or more return authorizations to dealer 140 (step 230). In one embodiment, the return authorization may be selected from a list of possible authorizations. The return authorizations may include, for example, approval to return one or more items, disapproval to return one or more items, approval to scrap, and the like. The return authorization may be based, in part, on the return recommendation. For example, if the dealer 140 receives a recommendation to keep one or more parts and dealer 140 accepts the recommendation, those one or more parts may not receive a return authorization. However, if dealer 140 receives a recommendation to keep one or more parts and dealer 140 rejects the recommendation, those one or more parts may receive a return authorization. Similarly, if dealer 140 receives a recommendation to return one or more parts and dealer 140 rejects the recommendation, dealer 140 may not receive a return authorization for those parts. In addition, if dealer 140 receives a recommendation to return one or more parts and dealer 140 accepts the recommendation, dealer 140 may not receive a return authorization for those parts. Each of the items on the wishlist may receive a return recommendation, a return authorization, both, or neither. It is anticipated that there may be any combination of recommendations to keep, recommendation to return, acceptances of the recommendations, and/or rejections of the recommendations. In one embodiment, the return authorization may be provided in an electronic format. Alternatively and/or additionally, the return authorization may be accompanied by return authorization paperwork and/or tags for each of the parts authorized for return. The paperwork may include a Part Return Authorization (PRA) number and a complete list of parts authorized for return. The tags may include data associated with the return of the part, such as, for example, the part number, dealer information, country of origin, and the like.

Upon receipt of the return authorization, dealer 140 may prepare the one or more parts approved for return (step 235). Preparing one or more parts approved for return may include completing paperwork associated with the return, attaching tags to each of the one or more parts, packaging the parts for shipment, and the like. Once dealer 140 has completed preparation for return, dealer 140 may then ship the part to the distributor. Shipment may be done through any known mechanisms and infrastructure, such as, for example, freight, mail, courier, parcel, and the like.

Returned parts are then processed by a parts processor associated with the parts distributor (step 240). Processing may include inspection of the returned parts and validating the actual returned parts with the return authorization list. In addition, processing may include verifying the date of return falls within an authorized return period, i.e., a not-before date, a no-later-than date, a range of dates, and the like. The parts processor may be, for example, a warehouse, a distribution center, a stockroom, etc. In one exemplary embodiment, the parts processor may be a parts warehouse associated with the parts distributor.

Once the returned parts are processed, the dealer 140 may be issued a credit for the returned parts (step 245). Alternatively and/or additionally, if a recommendation to transfer one or more parts was provided to dealer 140 and accepted by dealer 140, resulting in a transfer of one or more parts, then a credit may be issued for the cost of the transfer. Data associated with the amount of credit and/or method of credit issuance may be found in database 115 of return management computing system 110. In one embodiment, credit may be determined and/or issued by return management computing system 110. For example, return management computing system 110 may determine that a part has been returned and that a credit is due. In some embodiments, credit may be determined and/or issued by the parts distributor. Alternatively and/or additionally, return management computing system 110 may forward the return and/or credit data to another entity for further processing. The entity may include, for example, an accountant or accounting group, a bank or financial institution, etc. In some embodiments, the entity may be associated with the parts distributor. Credit may be issued by any means known in the art, such as, for example, check, electronic funds transfer, account credit, parts coupons, product credit, etc.

In an exemplary embodiment, dealer surplus returns may be scheduled by the return management computing system 110 of the parts distributor on a semi-annual basis, and every fourth return cycle may be targeted for low dollar returns, i.e., returns below a specified dollar amount. Based on data found in database 115, return management computing system 110 may automatically initiate the semi-annual surplus dealer return by way of an electronic notification, such as a dealer-specific posting on an authorized Website accessible by network 130. Dealer 140 may, in turn, access the authorized Website by means of network 130 and respond to the invitation. The response may include a list of items (e.g., wishlist) that dealer 140 selects for return to the parts distributor. The return management computing system 110 may automatically analyze the list of items, providing an item-specific recommendation, using data found in database 115. That is, for each item on the wishlist, return management computing system 110 may access database 115 and provide an item specific analysis for each item on the wishlist. Based on the results of that automated analysis, return management computing system 110 may provide a recommendation for each item on the wishlist including, for example, recommendations to keep one or more items, recommendations to return one or more items, recommendations to transfer one or more items, recommendations to reorder one or more items, and/or recommendations to scrap one or more items. The return recommendation may include any combination of these item-specific recommendations. The return recommendation may be posted on the dealer-specific Website. Dealer 140 may access the dealer-specific Website and accept or reject each item-specific recommendation. In some cases, the dealer 140 may accept or reject the entire set of return recommendations.

Once dealer 140 has responded to the recommendation, return management computing system 110 may automatically review the response and provide a return authorization for one or more parts. As mentioned above, the return authorization may be based on the response by dealer 140 to the return recommendation. The return authorization may include an authorization number and tags for the one or more parts authorized for return to the parts distributor. Dealer 140 may prepare the one or more parts for shipment and, upon receipt of those parts, the parts distributor may validate and issue a credit to dealer 140 for the return of those parts.

The disclosed embodiments may be implemented with automated processing of any type of return. The disclosed embodiments may achieve improved processing of returns, including improved feedback to dealers on the value of returning the part to the part distributor. In particular, the disclosed embodiments may analyze, identify, and/or assess parts for return and provide information to dealers on those parts. The disclosed embodiments may further automate authorization of dealer returns.

Further, the disclosed embodiments are not limited to processes between a dealer and a distributor. For example, the disclosed embodiments may be applicable to goods other than parts, such as, retail items, wholesale items, and/or consumer goods. In addition, the disclosed embodiments may be used within a business entity. The business entity may include divisions, groups, etc. that interact as sub-entities for the business entity. The sub-entities may act as a user of a good supplied by a supplier sub-entity within the same business entity, such as a manufacturing business with supply division, production line division, etc.

It will be apparent to those skilled in the art that various modifications and variations can be made in the automated processing of returns. It is intended that the specification and examples be considered as exemplary only, with a true scope of the disclosed embodiments being indicated by the following claims and their equivalents.

What is claimed is:

1. A method for processing dealer returns, comprising:
receiving a list of parts from a dealer, wherein the list of parts includes at least one part the dealer seeks to return to a supplier of the part;
determining a return recommendation for each part included in the list of parts, wherein the return recommendation includes a suggested disposition for the part;
providing the return recommendation to the dealer;
receiving a response to the return recommendation from the dealer; and
providing a return authorization to the dealer based on the return recommendation and the dealer response, wherein the return authorization includes an authorized disposition for each part included in the list of parts.

2. The method as in claim 1, wherein determining the return recommendation further includes:
accessing a database, wherein the database includes data associated with each part included in the list of parts; and
providing the return recommendation based on the data.

3. The method as in claim 1, wherein providing the return authorization further includes:
providing, for each part included in the list of parts and authorized for return, at least one tag; and
providing to the dealer a return authorization number.

4. The method as in claim 3, wherein providing a return authorization further includes:
determining, for each part included in the list of parts and authorized for return, a country of origin of the part; and
including the determined country of origin on the generated tag.

5. The method as in claim 1, wherein the return recommendation is selected from a list of return recommendations.

6. The method as in claim 1, wherein the return recommendation includes a recommendation to keep one or more parts.

7. The method as in claim 1, wherein the return recommendation includes a recommendation to transfer one or more parts.

8. The method as in claim 1, wherein the return recommendation includes a recommendation to reorder one or more parts.

9. The method as in claim 1, wherein the dealer response includes at least one of an acceptance or a rejection of the return recommendation.

10. The method as in claim 1, further including:
receiving one or more returned parts based on the return authorization;
inspecting the one or more returned parts; and
issuing a credit to the dealer for the one or more returned parts.

11. A computer-readable medium including instructions for performing a method, when executed by a processor, for processing dealer returns, comprising:
receiving a list of parts from a dealer, wherein the list of parts includes at least one part the dealer seeks to return to a supplier of the part;
determining a return recommendation for each part included in the list of parts, wherein the return recommendation includes a suggested disposition for the part;
providing the return recommendation to the dealer;
receiving a response to the return recommendation from the dealer; and
providing a return authorization to the dealer based on the return authorization and the dealer response, wherein the return authorization includes an authorized disposition for each part included in the list of parts.

12. The computer-readable medium of claim 11, wherein determining the return recommendation further includes:
accessing a database, wherein the database includes data associated with each part included in the list of parts; and
providing the return recommendation based on the data.

13. The computer-readable medium of claim 11, wherein providing the return authorization further includes:
determining, for each part included in the list of parts and authorized for return, a country of origin of the part;
generating, for each part included in the list of parts and authorized for return, at least one tag, wherein the tag includes the determined country of origin; and
providing to the dealer a return authorization number and the at least one tag.

14. The method as in claim 11, wherein the return recommendation is selected from a list of return recommendations.

15. The computer-readable medium of claim 11, wherein the return recommendation includes a recommendation to keep one or more parts.

16. The computer-readable medium of claim 11, wherein the return recommendation includes a recommendation to transfer one or more parts.

17. The computer-readable medium of claim 11, wherein the return recommendation includes a recommendation to reorder one or more parts.

18. The computer-readable medium of claim 11, further including:
receiving one or more returned parts based on the return authorization;
inspecting the one or more returned parts; and
issuing a credit to the dealer for the one or more returned parts.

19. A system for processing dealer returns, comprising:
a first computer system configured to generate and transmit a list of items for potential return, wherein the list of items includes at least one item; and
a second computer including:
a memory including program code configured to process dealer returns; and
a processor configured to execute the program code to determine a return recommendation for each item included in the list of items received from the first computer system, determine a return recommendation for each item on the list of items, wherein the return recommendation includes a suggested disposition for the item, and provide a return authorization based on the return recommendation for any item identified for return by the first computer system.

20. The system as in claim 19, wherein the second computing system is further configured to execute program to process one or more returned items based on the return authorization and issue a credit for the one or more returned items.
